(19) United States
(12) Patent Application Publication
(10) Pub. No.: US 2022/0366492 A1
(43) Pub. Date: Nov. 17, 2022

(54) AUTOMATICALLY MANAGING DRAW REQUEST PROCESSING IN ACCORDANCE WITH EXPLICIT LENDER POLICIES

(71) Applicant: Northwest Construction Control, Inc., Sumner, WA (US)

(72) Inventors: Charles Manning, Seattle, WA (US); Cathryn Binder, Spanaway, WA (US); Patrick Dunagan, Gig Harbor, WA (US)

(21) Appl. No.: 17/734,914

(22) Filed: May 2, 2022

Related U.S. Application Data
(60) Provisional application No. 63/189,344, filed on May 17, 2021.

(51) Int. Cl. G06Q 40/02; G06Q 50/08

(52) U.S. Cl. CPC G06Q 40/025; G06Q 50/08

(57) ABSTRACT

A construction loan management facility is described. The facility stores a construction loan management policy data structure that contains an entry for each of multiple lenders. Each entry contains information identifying the lender. For each of multiple construction project budget categories, each entry also contains information specifying a loan processing policy for the construction project budget category. The facility can use the contents of the data structure to automatically supervise the actions of a loan processor acting with respect to a draw request for a loan of an identified lender.

### CROSS-REFERENCE TO RELATED APPLICATION

This application claims the benefit and priority to provisional U.S. Application No. 63/189,344, filed May 17, 2021, the entirety of which is hereby incorporated by reference. In cases where a document incorporated herein by reference conflicts with the present disclosure, the present disclosure controls.

### BACKGROUND

Construction loans finance the building or renovation of a home or other building. A lender who makes a construction loan for a project disburses portions of its total amount over time to a contractor responsible for executing the project. It is typical for a lender to make most or all of these disbursement payments in response to draw requests from the contractor.

In conventional approaches to processing draw requests, an employee of the lender referred to as a draw request processor receives draw requests for lenders, and is responsible for their processing. They typically make a recommendation to a loan officer about whether to disburse funds in response to each draw request, and the amount of the disbursement. If and when the loan officer provides authorization to the draw request processor, the draw request processor makes a disbursement in accordance with the authorization.

### BRIEF DESCRIPTION OF THE DRAWINGS

FIG. 1 is a network diagram showing a sample environment in which the facility operates in some embodiments.

FIG. 2 is a block diagram showing some of the components typically incorporated in at least some of the computer systems and other devices on which the facility operates.

FIG. 3 is a flow diagram showing a process performed by the facility in some embodiments to onboard a lender and add loans by that lender to the list of loans for which the facility manages draw requests.

FIG. 4 is display diagram showing a sample display presented by the facility in some embodiments to begin the process of establishing lender policies.

FIG. 5 is a display diagram showing a sample display presented by the facility in some embodiments to continue establishing policies for a lender.

FIG. 6 is a display diagram showing a sample display presented by the facility in some embodiments to further continue establishing policies for a lender.

FIG. 7 is a display diagram showing a sample display presented by the facility in some embodiments to continue establishing policies for the lender.

FIG. 8 is a display diagram showing a sample display presented by the facility in some embodiments to enable a lender user to perform certain aspects of initiating a new project for a loan made by the lender.

FIG. 9 is a display diagram showing a sample display presented by the facility in some embodiments to display a budget and its supporting documentation to a lender user and received their input on it.

FIG. 10 is a flow diagram showing a process performed by the facility in some embodiments to manage draw requests.

FIG. 11 is a display diagram showing a sample display presented by the facility in some embodiments in order to permit contractors and other categories of users to sign into a web interface provided by the facility.

FIG. 12 is a display diagram showing a sample display presented by the facility in some embodiments to provide a dashboard to a contractor user.

FIG. 13 is a display diagram showing a sample display presented by the facility in some embodiments to enable a contractor user to submit a draw request.

FIG. 14 is a display diagram showing a sample display presented by the facility in some embodiments to solicit the borrower's endorsement of a draw request submitted by the borrower's contractor.

FIG. 15 is a display diagram showing a sample display presented by the facility in some embodiments to permit a lender to arrange an inspection.

FIG. 16 is a display diagram showing a sample display presented by the facility in some embodiments to permit a lender to approve and/or edit a draw in response receiving an inspection report for the corresponding project.

FIG. 17 is a display diagram showing a sample display presented by the facility in some embodiments to further enable a lender user to edit and/or approve a draw request.

FIG. 18 is a display diagram showing a sample display presented by the facility in some embodiments to provide details of the draw payment to a project's contractor and borrower.

### DETAILED DESCRIPTION

The inventors have recognized significant disadvantages of conventional approaches to processing draw requests for construction loans. In particular, these approaches require significant levels of manual, inefficient, subjective work on the part of both a lender's draw request processors and its loan officers. Also, as a result of the subjective dimension brought to their work by both draw request processors and its loan officers, the results of the processing can be inconsistent across loans, and also inconsistent with the lender's policies and priorities. Further, the need to involve a loan officer in every disbursement decision places a high burden on their time. Additionally, communication among those involved in a construction loan—such as draw request processors, loan officers, contractors, and borrowers—tends to be ad hoc, and therefore inconsistent.

In response to recognizing these disadvantages of conventional techniques for processing draw requests, the inventors have conceived and reduced to practice a software and/or hardware facility for automatically managing draw request processing in accordance with explicit lender policies (“the facility”).

The facility performs a configuration process with respect to each lender, in which a person of authority at the lender selects policies in accordance with which the facility will manage the processing for draw requests received for the lender's construction loans. In various embodiments, this configuration includes policies specifying treatment for different categories of disbursements, including those that are not inspectable, and are not otherwise monitorable, such as soft costs whose amounts can't be determined in advance, like permits and fees; hard costs that aren't clearly defined or labeled; contingency buffer funds to protect against changes in material costs; and profit and overhead allowances for contractors. The configuration also includes policies about whether processors can adjust disbursements of different types without consultation, by how much, and whether notifications of such adjustments are automatically sent to loan officers. By default, this lender configuration applies to all of the lender's loans. In some embodiments, however, it can be customized for a particular loan.

When a draw request is submitted by a contractor, the facility processes it accordance with the policy configuration the lender has specified, either at the loan level, or at the lender level. This processing can involve automatic determinations whether to disburse, amount to disburse, and whether to seek instructions from a processor, a processor and a loan officer, or neither.

Contractors can log into a web interface provided by the facility to directly input budgets and draw requests, upload documentation, and see resolutions. Borrowers can monitor status. Inspectors see and accept inspection requests, and input inspection reports.

By operating in some or all of these ways, the facility renders construction loan administration more efficient while consistently giving effect to the lender's policies and priorities, yet retaining flexibility to handle special situations appropriately, and improves its visibility and predictability to all involved parties.

Also, the facility improves the functioning of computer or other hardware, such as by reducing the dynamic display area, processing, storage, and/or data transmission resources needed to perform a certain task, thereby enabling the task to be permitted by less capable, capacious, and/or expensive hardware devices, and/or be performed with lesser latency, and/or preserving more of the conserved resources for use in performing other tasks. For example, by presenting making automatic determinations in accordance with policy configurations, the facility reduces the total processing resources needed to seek resolution of each draw request from a processor, a loan officer or both.

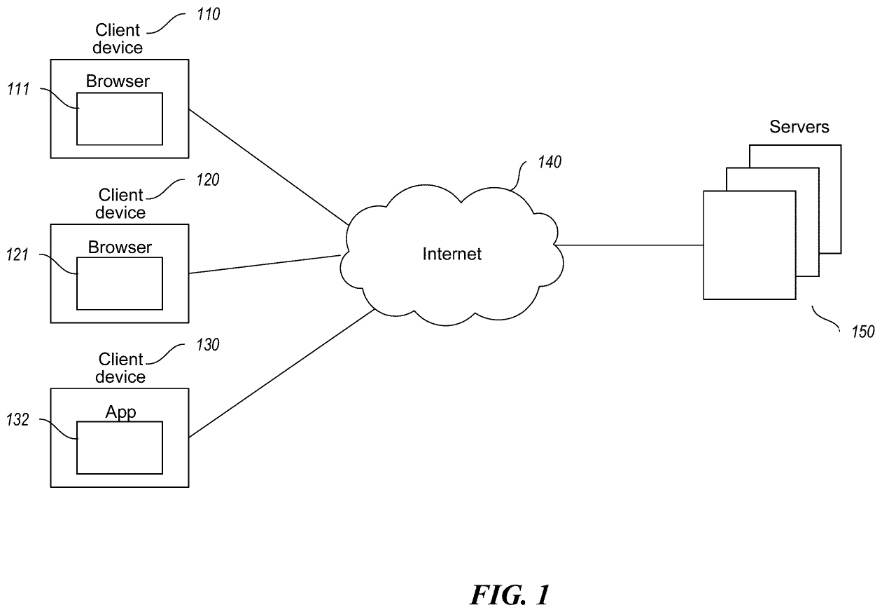

FIG. 1 is a network diagram showing a sample environment in which the facility operates in some embodiments. A number of client devices 110, 120, and 130 are connected via the Internet 140 or another network to one or more servers 150 that operate an inspection arrangement platform. Some of the client devices—such as client device 110—execute a browser that interacts with the platform software on the server on behalf of a lender user, an inspector, or an administrative user for the facility using the client device, while other client devices—such as client device 130—execute a specialized mobile app or desktop application that interacts with the platform software on the server on behalf of a lender user, an inspector, or an administrative user for the facility using the client device.

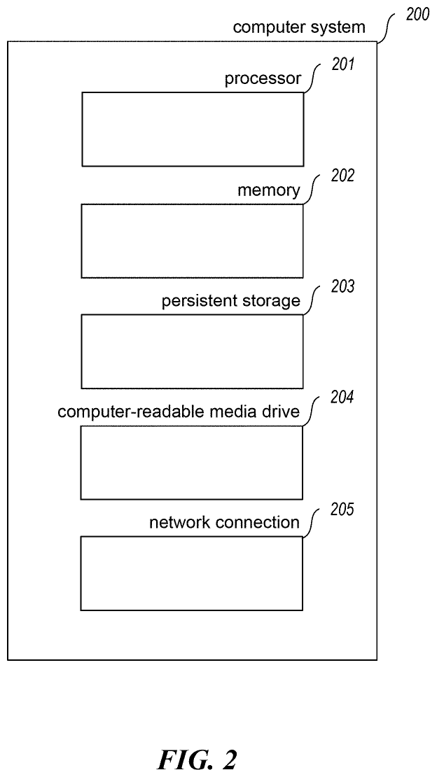

FIG. 2 is a block diagram showing some of the components typically incorporated in at least some of the computer systems and other devices on which the facility operates, including the devices shown in FIG. 1. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

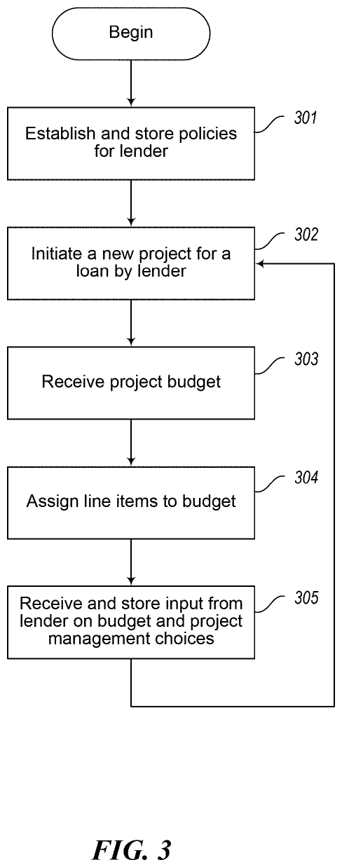

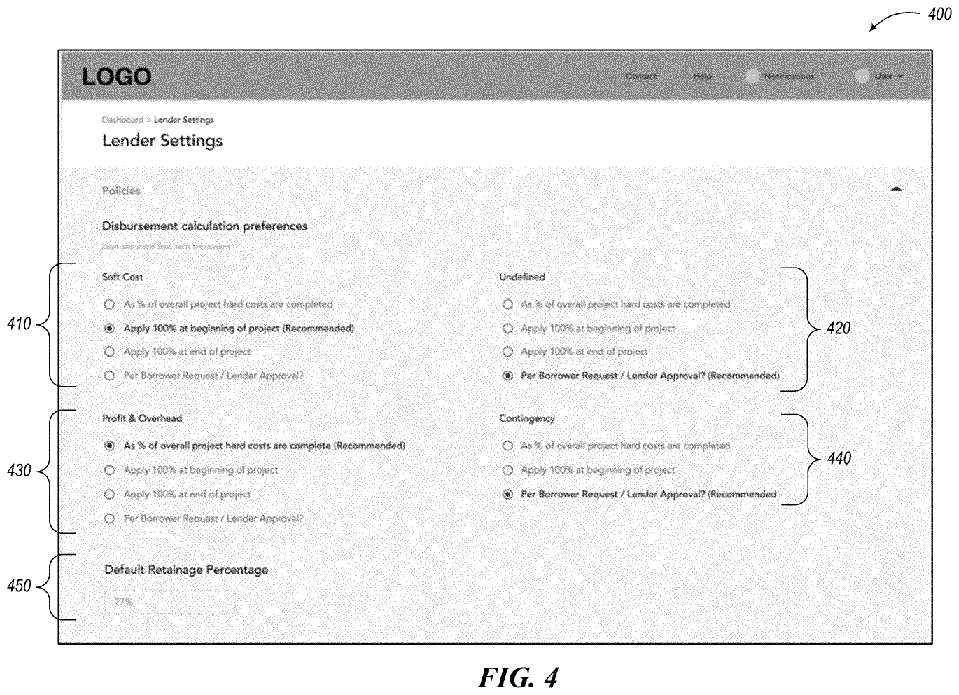

FIG. 3 is a flow diagram showing a process performed by the facility in some embodiments to onboard a lender and add loans by that lender to the list of loans for which the facility manages draw requests. In act 301, the facility establishes and stores lender-level polices for the lender. These are applied by default to each of the lender's loans, but can be overridden on a per-loan basis. FIGS. 4-7 shown an example of a lender user establishing policies for that lender.

FIG. 4 is display diagram showing a sample display presented by the facility in some embodiments to begin the process of establishing lender policies. In particular, the display 400 enables the lender user to specify how non-standard line items should be disbursed. The display 400 shows controls 410 that can be used to specify how soft costs are to be disbursed for the lender's loans; controls 420 for specifying how undefined costs should be disbursed for the lender's loans; controls 430 for specifying how profit and overhead should be disbursed for the lender's loans; controls 440 for specifying how contingencies should be disbursed for the lender's loans; and controls 450 for specifying a default retainage percentage for the lender's loans.

While FIG. 4 and each of the display diagrams discussed below show a display whose formatting, organization, informational density, etc., is best suited to certain types of display devices, those skilled in the art will appreciate that actual displays presented by the facility may differ from those shown, in that they may be optimized for particular other display devices, or have shown visual elements omitted, visual elements not shown included, visual elements reorganized, reformatted, or shown at different levels of magnification, etc.

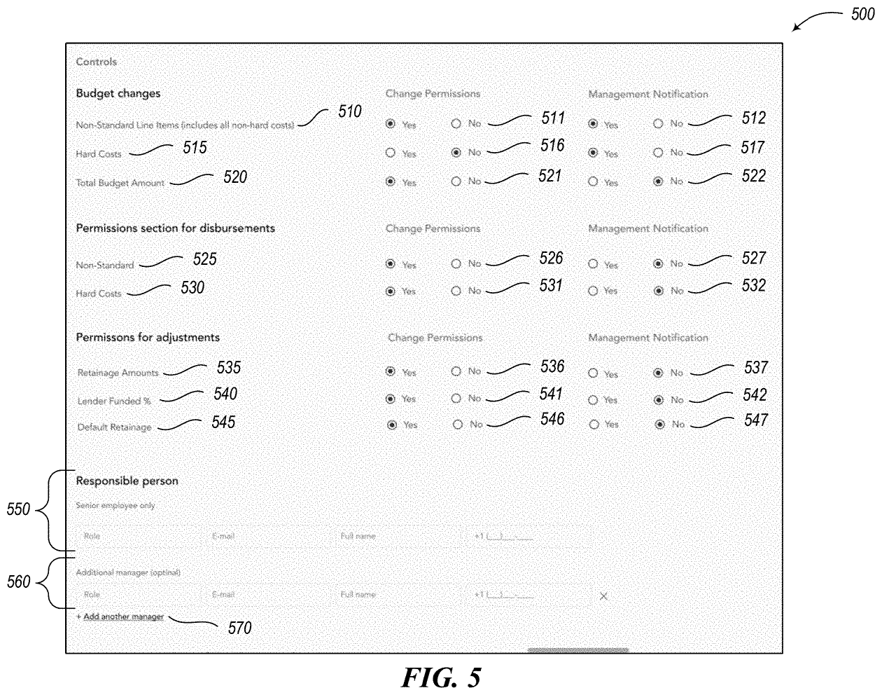

FIG. 5 is a display diagram showing a sample display presented by the facility in some embodiments to continue establishing policies for a lender. In particular, the display 500 enables the lender user to specify permissions and oversight levels for the lender's loan processors. For non-standard line item budget changes 510, the display includes a control 511 for specifying whether processors can make changes to these in disbursing them, and control 512 for specifying a loan officer or other management person should be notified when such changes are made. The display includes corresponding controls for hard costs budget changes 515, total budget amount budget changes 520, non-standard cost disbursements 525, hard cost disbursements 530, retainage amount adjustments 535, adjustments 540 to a lender funded percentage, and adjustments 545 to default retainage. The display also includes controls 550, 560, and 570 for adding responsible people at the lender to receive management notifications when generated for loan processor actions.

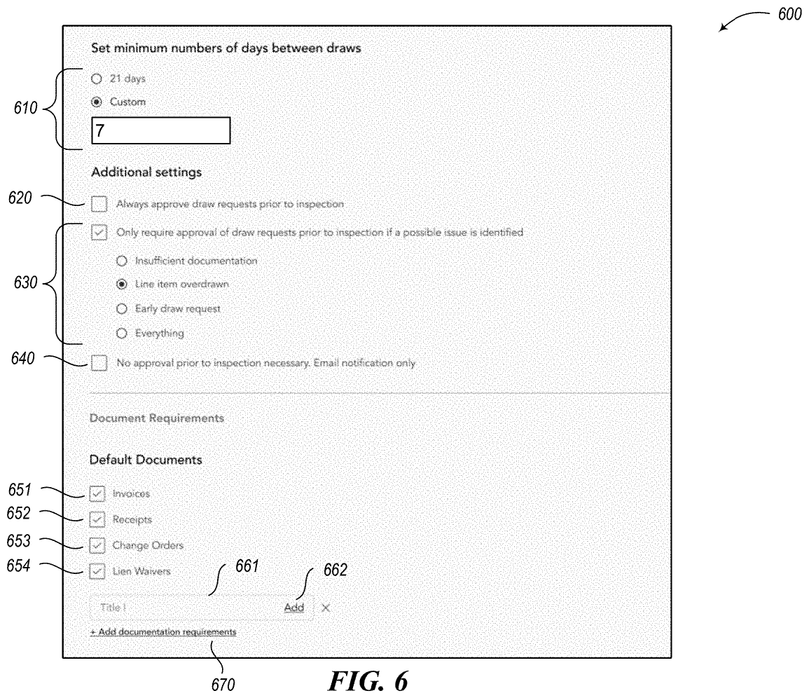

FIG. 6 is a display diagram showing a sample display presented by the facility in some embodiments to further continue establishing policies for a lender. In particular, the display 600 permits the lender user to specify disbursement controls for the lender. The display includes a control 610 for setting a minimum number of days that must elapse between draw payments; a control 620 for specifying whether draw requests are to always be approved before inspection; controls 630 for specifying conditions under which approval is required in approving draw requests before inspection; and a control 640 in order to specify that approval for draw requests prior to inspection will be the subject of email notification, but will not require approval. Controls 651-654 allow the lender user to specify types of documents that must be submitted in support of draw requests, and controls 661, 662, and 670 can be used to add additional document types that may be required.

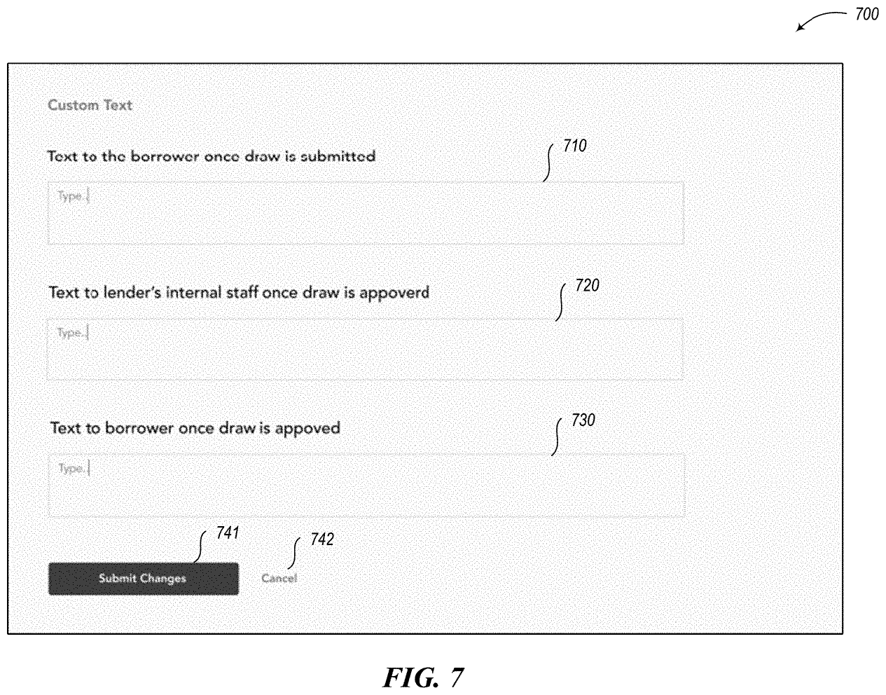

FIG. 7 is a display diagram showing a sample display presented by the facility in some embodiments to continue establishing policies for the lender. The display 700 includes a control 710 for entering text of a message to be shown or sent to the borrower when a draw request is submitted by a contractor; a control 720 for specifying text of a message to be sent to internal staff at the lender when a draw is approved; and a control 730 for specifying text of a message to be sent to the borrower when a draw is approved. This display also includes a control 741 for submitting the policies specified in displays 400, 500, 600, and 700, and a control 742 for canceling the process of establishing these policies.

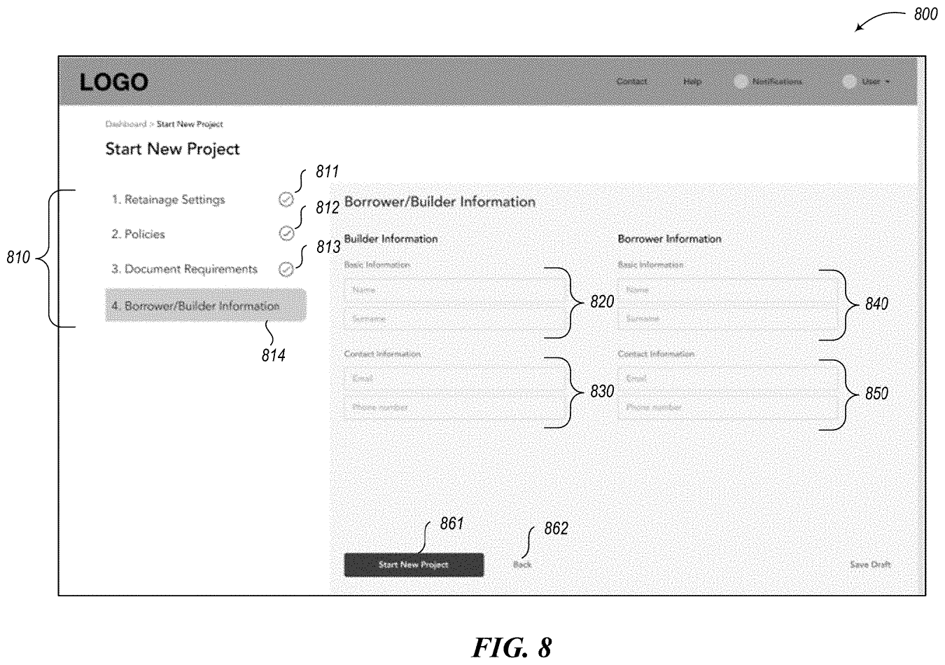

Returning to FIG. 3, in act 302, the facility initiates a new project for a loan made by the lender. Aspects of act 302 are shown in FIG. 8 and discussed below.

FIG. 8 is a display diagram showing a sample display presented by the facility in some embodiments to enable a lender user to perform certain aspects of initiating a new project for a loan made by the lender. The display 800 has a navigation panel 810 showing steps 811-814 of this process. It can be seen from the checkmarks for steps 811-813 that the lender user has already made many needed adjustments to the lender's default policies for retainage settings, polices, and document requirements. In display 800, the lender user provides borrower and builder information. In particular, the lender user enters identifying information 820 and contact information 830 for the builder, as well as identifying information 840 and contact information 850 for the borrower. The display also includes a control 861 that the lender user can activate in order to begin the new project on the basis of the entered information, and control 862 that the lender user can activate in order to go back to any of the three earlier steps 811-813.

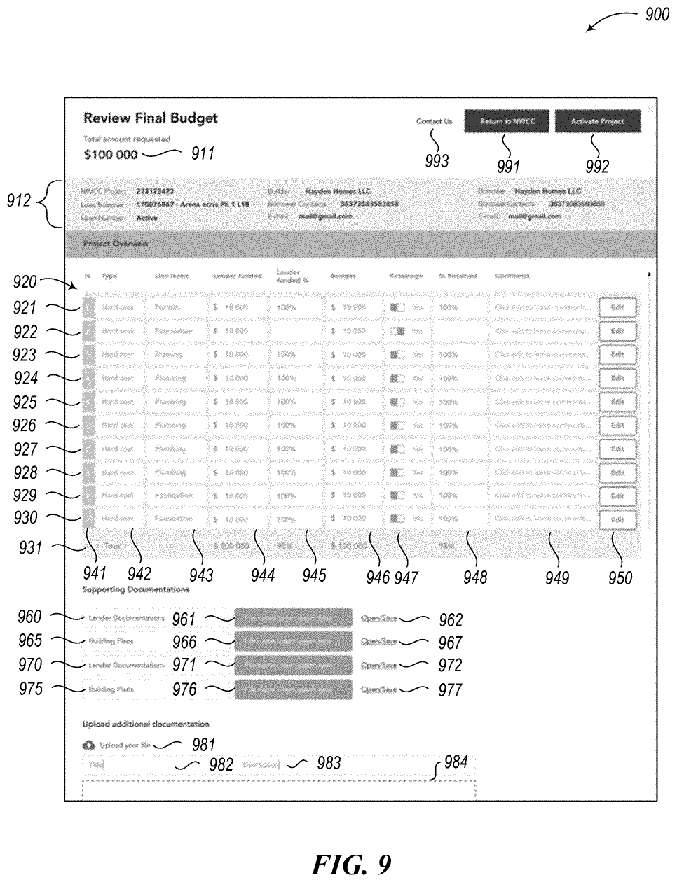

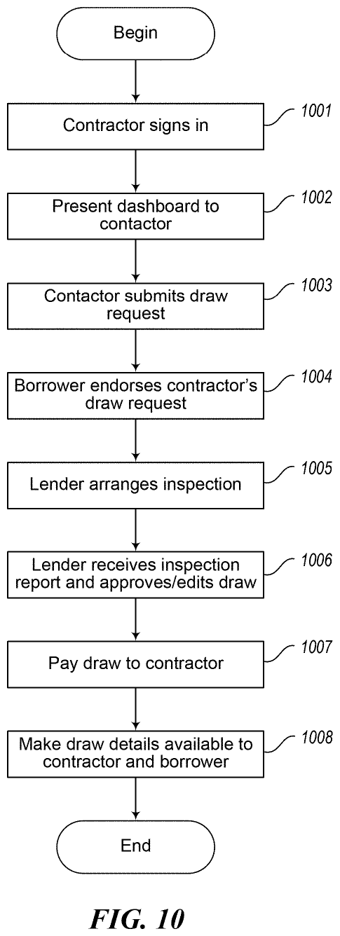

Returning to FIG. 3, in act 303, the facility receives a budget for the process, typically from the contractor. In some embodiments, the contractor uploads the project budget via the facility's web interface. In some embodiments, the contractor submits the budget in various other ways, such as by email, fax, upload to shared document repository, etc. In act 304, the facility assigns lines items to the budget received in act 303. In act 305, the facility receives and stores input from the lender on the budget and choices for managing the project in light of the budget. Act 305 is discussed below further in connection with FIGS. 9 and 10. After act 305, the facility continues in act 302 to initiate the next project for a loan made by the lender.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

FIG. 9 is a display diagram showing a sample display presented by the facility in some embodiments to display a budget and its supporting documentation to a lender user and received their input on it. The display includes an indication 911 of the total amount of the budget, and identifying information 912 for the project. The display also includes a table 920 made up of rows 921-930 each corresponding to a line item of the budget, and a total row 931 contain totals for certain columns. Each row is divided into the following columns, a line number item column 941, a line item type column 942, a line item name column 943, a lender funded column 944 indicating an amount for which the lender will fund the line item, a lender funded percentage column 945 indicating the percentage of the line item that the lender will found, a budget column 946 identifying the amount budgeted for the line item, a retainage column 947 indicating whether retainage will apply to the line item, a percentage retained column 948 indicating a percentage of the line item that will be retained, a comments column 949 containing comments made by the contractor or that may be made by the lender user about the line item, and control column 950 containing controls for editing or completing editing of the item item's row. For example row 921 indicates that line item number 1 is a “permits” hard cost, for which $10,000 is budgeted, all of which will be funded by the lender, and it will be subject at retainage at a 100% rate. Using the controls in the control column, the lender user can edit the values in the table in order to adjust the line items and/or their treatment. The display also includes access to different forms of supporting documentation 960, 965, 970, and 975. The lender user can use the associated controls to review these and/or augment them. Also, the lender user can use controls 981-984 in order to attach additional documentation to the budget.

The display also contains a control 991 that can be activated to return to the operators of the facility; a control 992 that can be activated in order to begin the project based upon the adjusted budget; and a control 993 that can be activated in order to contact the operators of the facility.

FIG. 10 is a flow diagram showing a process performed by the facility in some embodiments to manage draw requests. In act 1001, the contractor signs into a web interface provided by the facility.

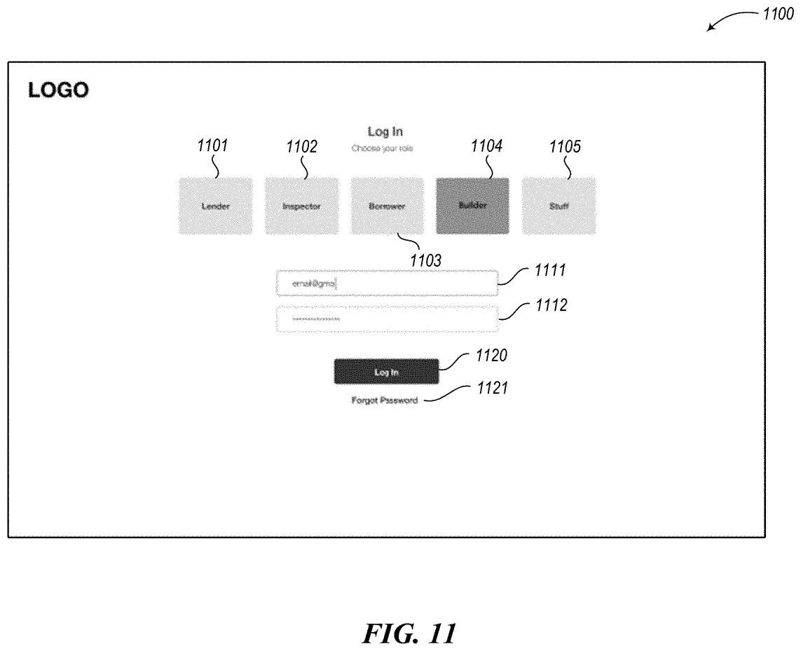

FIG. 11 is a display diagram showing a sample display presented by the facility in some embodiments in order to permit contractors and other categories of users to sign into a web interface provided by the facility. The display 1100 includes controls 1101-1105 that a user may select in order to specify their role with respect to the facility. The display also includes fields 1111 and 1112 in which the user enters their user name or email address and password. The display further includes a control 1120 that the user can activate in order to log in based upon the entered credentials, and a control 1121 that the user can activate if they forgot their password in order to perform password recovery.

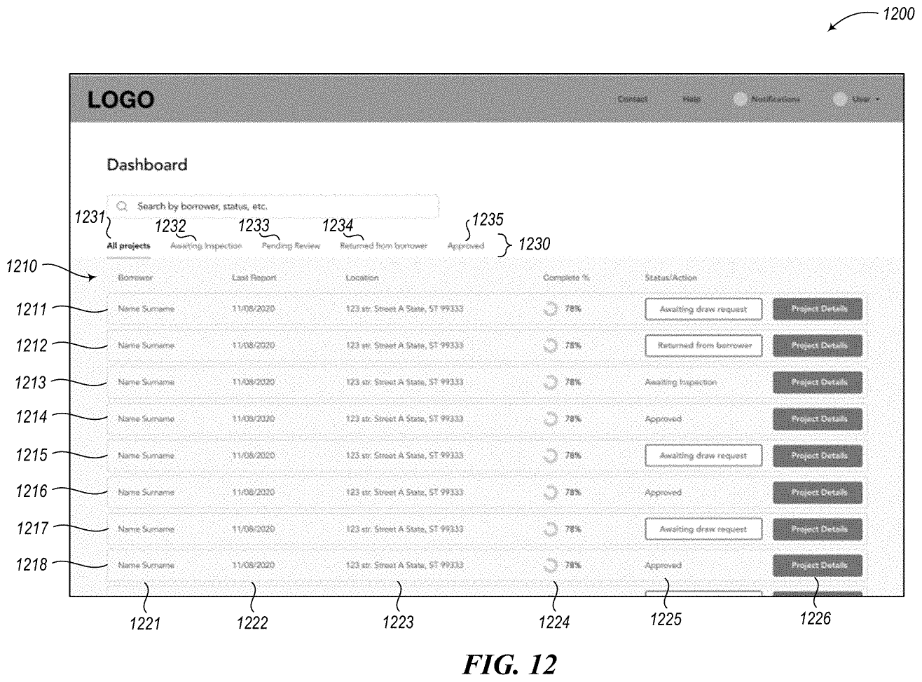

Returning to FIG. 10, in act 1002 the facility presents a dashboard to the contractor. FIG. 12 discussed below illustrates such a dashboard.

FIG. 12 is a display diagram showing a sample display presented by the facility in some embodiments to provide a dashboard to a contractor user. The display 1200 includes a table 1210 showing information and providing access to the contractor's projects that are being managed by the facility. Each of rows 1211-1218 corresponds to a different project of the contractor funded by a loan being managed using the facility. Each row is divided into the following columns: a borrower column 1221 identifying the borrower of the loan, who is generally the owner of the building on which construction is being performed; a last report column 1222 containing a date on which an inspection report or other source of information about the status of the project was received; a location column 1223 containing the street address of the project building; a complete percentage column 1224 indicating the degree of completion of the project; a status or action column 1225 containing either a present status of the project, or a control for taking action with respect to the project; and a project details column 1226 providing access to additional details about the project, such as its budget, draw requests and disbursements, inspection reports, etc. For example, row 1211 corresponds to a project at 123 Street A in State, ST 99333 that is 78 percent complete and awaiting a draw request. The contractor user can activate the awaiting draw request control at the intersection of row 1211 and column 1225 in order to submit a draw request for the project to which row 1211 corresponds. Various other projects shown in other rows has other statuses, and/or have controls for performing different actions that are appropriate in the case of each of these projects.

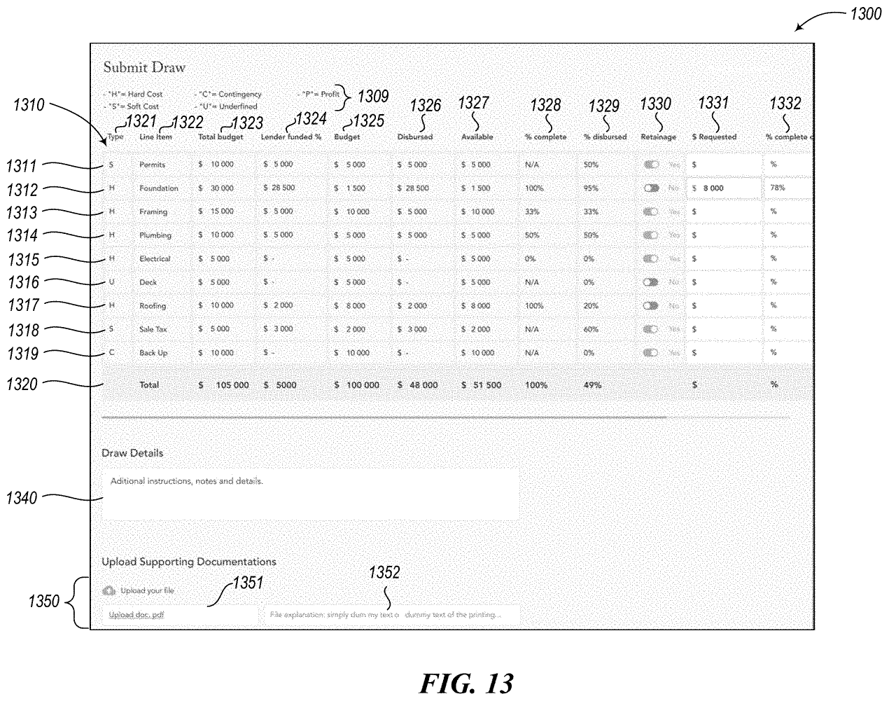

Returning to FIG. 10, in act 1003, the contractor uses the dashboard presented in act 1002 to submit a draw request for a particular project. Act 1003 is discussed in greater detail below in connection with FIG. 13.

FIG. 13 is a display diagram showing a sample display presented by the facility in some embodiments to enable a contractor user to submit a draw request. The display 1300 contains a table 1310 similar to the table 920 shown in FIG. 9 that details the budget by line item. Table 1310 contains three columns 1331-1333 that are populated by the contractor user to specify the draw that is being requested. In particular, for a line item such as the line item to which row 1312 corresponds that is the subject of the draw request, the contractor user populates a dollars requested amount in column 1331 indicating the amount of money the contractor is requesting presently for the line item; a percentage of the line item that has been completed as asserted by the contractor in column 1332; and text in comments column 1333 (not shown) that can describe the work that has been done on this line item and why the indicated level of disbursement is merited. The contractor user populates these three columns for any line items that are the subject of the draw request, and can enter additional text in field 1340 about the draw request and why it is merited. Also, the contractor user can use controls 1350 to upload documentation that shows why the draw request is proper and should be approved.

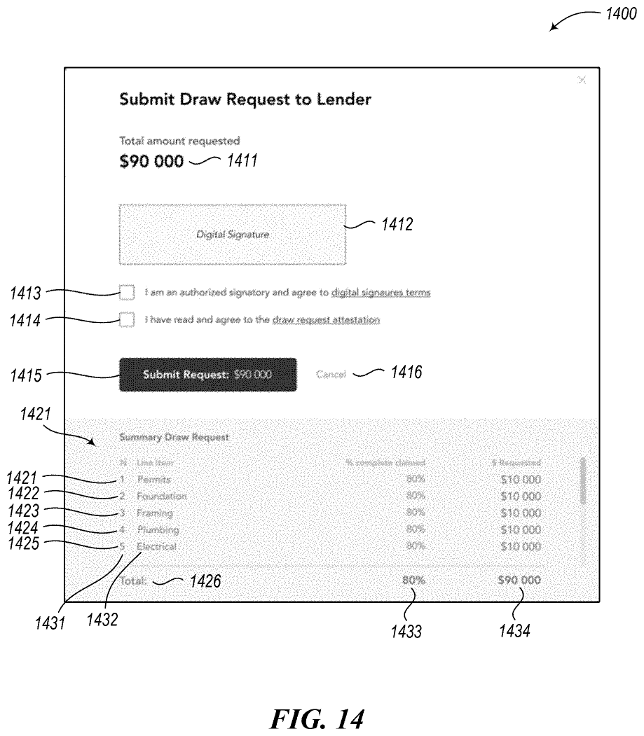

Returning to FIG. 10, in act 1004, the facility solicits the borrower's endorsement of the draw request submitted by the contractor in act 1003. Act 1004 is discussed below in connection with FIG. 14.

FIG. 14 is a display diagram showing a sample display presented by the facility in some embodiments to solicit the borrower's endorsement of a draw request submitted by the borrower's contractor. In various embodiments, the display 1400 is displayed to the borrower via the web interface provided by the facility after login by the borrower, or is sent to the borrower by email, text, etc. The display shows the total amount 1411 requested in the draw request, as well as a table 1420 showing details of the amount requested for each line item 1421-1426. If the borrower approves, the borrower applies a digital signature to control 1412—such as by signing a cursive signature on a touch screen, or providing any other suitable signature in connection with control. The borrower also ticks check boxes 1413 and 1414 with respect to the authorization, and then can activate a submit 1415 to submit their approval, or a cancel control 1416 to end the approval process.

Returning to FIG. 10, in act 1005, the lender arranges a draw inspection as a basis for deciding whether to approve the requested draw disbursement.

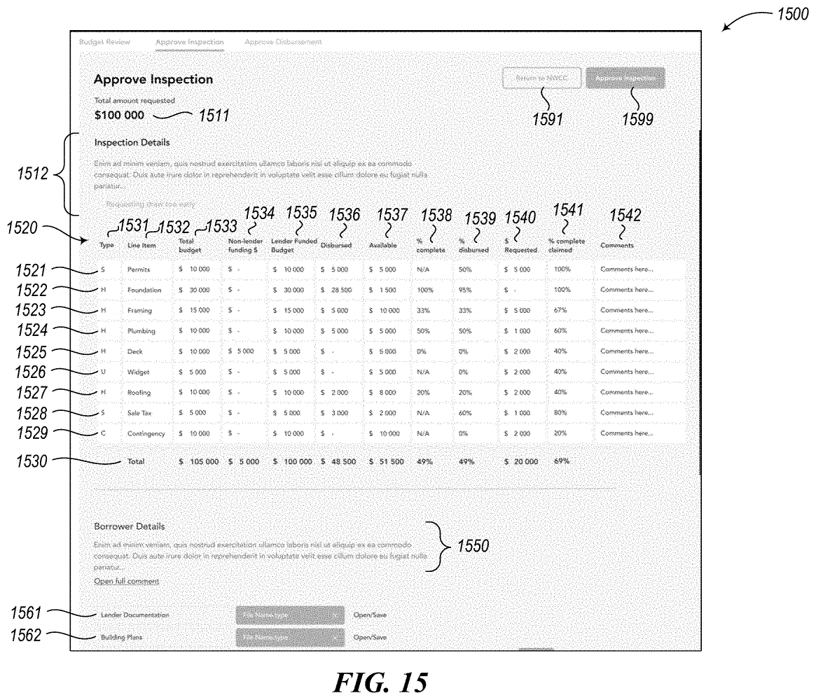

FIG. 15 is a display diagram showing a sample display presented by the facility in some embodiments to permit a lender to arrange an inspection. In some embodiments, the facility presents this display 1500 in response to the borrower's endorsement of their contractor's draw request in act 1004. In addition to the total amount requested 1511 in the contractor's draw request on the details 1520 of this request, the display includes a control 1599 that the lender user can activate in order to request scheduling of an inspection for the draw request by the facility.

In some embodiments, the facility assists in the arrangement of this inspection, such as in the manners described in U.S. Provisional Patent Application No. 63/176,540, filed on Apr. 19, 2021, entitled “OPTIMIZING THE PLANNING OF CONSTRUCTION LOAN INSPECTIONS ON BEHALF OF ONE OR MORE LENDERS”, which is hereby incorporated by reference in its entirety. Where the present application conflicts with any document incorporated herein by reference, the present application controls.

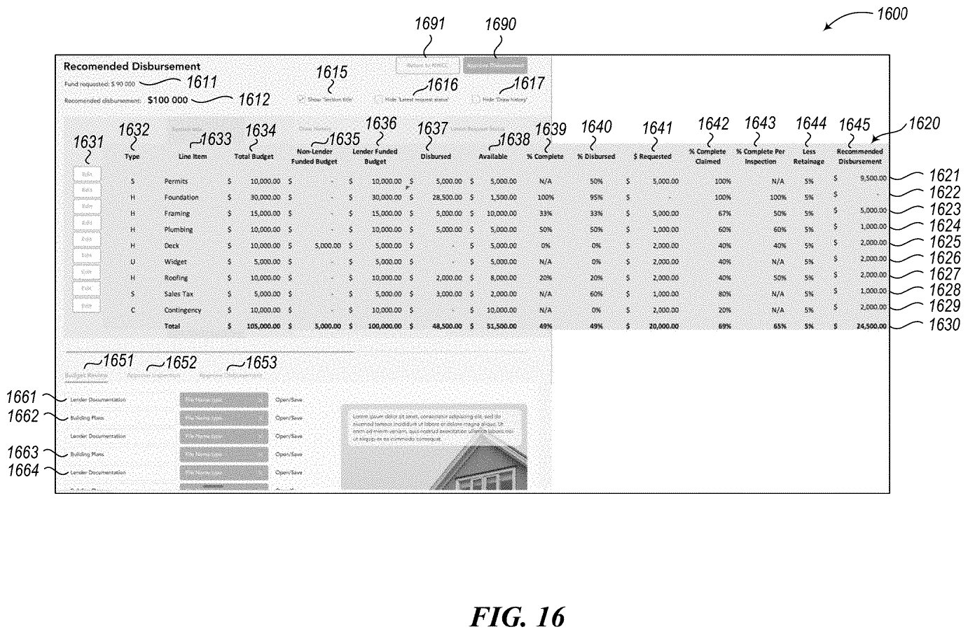

In act 1006, the lender approves the inspection. Details of act 1006 are discussed below in connection with FIG. 16.

FIG. 16 is a display diagram showing a sample display presented by the facility in some embodiments to permit a lender to approve and/or edit a draw payment in response receiving an inspection report for the corresponding project. The display 1600 includes identifying information 1611 for the project and/or loan. It also contains an indication 1611 of the funds requested in the draw request, and a disbursement amount 1612 recommended by the facility. It also contains a table 1620 providing details of the draw request, in which each of rows 1621-1629 corresponds to a line item of the budget, and aggregate row 1630 contains aggregation results for many of the columns. Each row is divided into the following columns: an edit control column 1631 that the bank user can activate in order to edit the contents of the row; a line item type column 1632; a line item name column 1633; a total budget column 1634 indicating the total budget for the line item; a non-lender funded budget column 1635 indicating the portion of the line item funded by a party other than the lender; a lender funded budget column 1636 indicating the amount the lender will fund for the line item. Columns 1637-1640 in section 1652 relate to the draw history for this project: a disbursed column 1637 identifying an amount that has already been disbursed for the line item; an available column 1638 indicating the amount of the lender funded budget that is still available to disburse; a percent complete column 1639 indicating the extent to which the contractor has completed the line item; a percent disbursed column 1640 indicating the percentage of lender funded budget for the line item that has been disbursed. Columns 1641-1643 in section 1653 related to the status of the latest draw request: dollars requested column 1641 indicates the number of dollars the contractor has requested to be disbursed for this line item in the requested draw; percentage complete claimed column 1642 indicates the extent of completion asserted by the contractor for the line item; percentage inspected complete column 1643 indicates the extent of completion of the line item reflected by the inspection report. Column 1644-1646 in section 1654 relate to details of the disbursement: draw approved per inspection column 1644 indicates how much of the requested dollars should be paid based upon the inspection report; less retainage column 1656 indicates the percentage of the previous column that should be held in retainage; and recommended disbursement column 1646 indicates how many dollars remain to be paid after the allocation to retainage. Column 1647 (not shown) contains a control for displaying all the comments for a line item, and column 1648 (not shown) contains a control for displaying a history of all the edits for the line item. The lender user can use controls 1615-1617 to hide or show any of sections 1651-1653. The user can also use controls 1651-1653 and 1661-1664 to display documentation associated with the loan. After reviewing the contents of the table, the lender user can revise the contents of the recommended disbursement column in order to adjust the amounts to be disbursed per line item, within their authority, and subject to notification of a bank officer in accordance with the lender policies. Once the lender user is satisfied with the contents of the recommended disbursement column, the lender user can activate a pay draw control 1699 in order to pay a draw to the contractor in accordance with contents of this column.

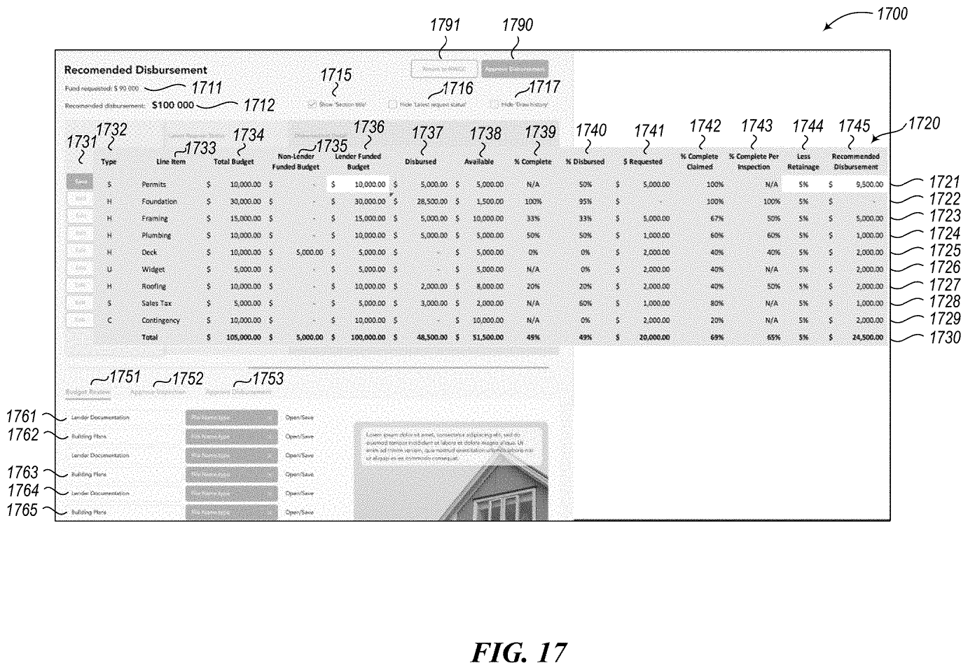

FIG. 17 is a display diagram showing a sample display presented by the facility in some embodiments to further enable a lender user to edit and/or approve a draw request. In display 1700 it can be seen that the user is entering an updated disbursement amount for the line item represented by row 1728 before activating approve disbursement control 1799.

Returning to FIG. 10, in act 1007, the facility causes the draw to be paid to the contractor in accordance with the edits and/or approval of act 1006. In act 1008, the facility makes the details of the draw payment available to the contractor and borrower, such as via the web interface provided by the facility. After act 1008, this process concludes.

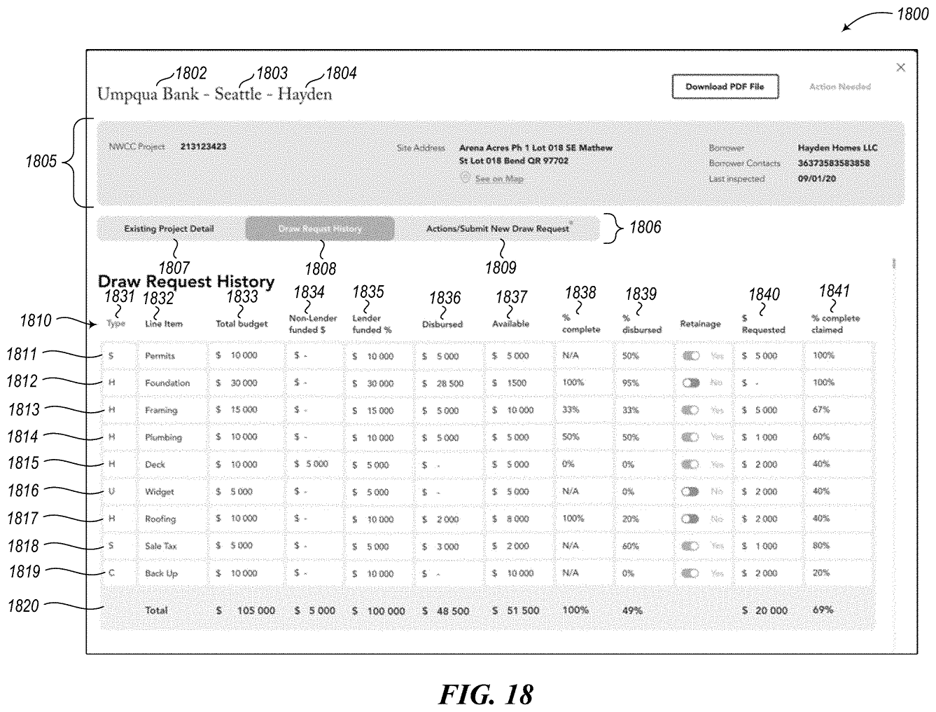

FIG. 18 is a display diagram showing a sample display presented by the facility in some embodiments to provide details of the draw payment to a project's contractor and borrower. The display 1800 contains information 1802-1804 identifying the loan and project. It contains further identifying information for the loan and project 1805. The display also includes a navigation control 1806 that the user can interact with in order to display existing project detail 1807, a draw request history—as here— 1808, or an action/submit new draw request 1809. The display also includes a table 1810 containing details of the payment of the draw with respect to the budget's individual line items, each represented by one of rows 1811-1819, and totaled in row 1820.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system for processing a construction loan draw request on behalf of a lender, comprising:
receiving input specifying processing policies of the lender;
storing the specified processing policies on behalf of the lender;
receiving a draw request from a contractor, the draw request identifying (a) a construction loan made by the lender for which the contractor is performing a construction project, (b) a portion of the total loan amount for which the contractor seeks disbursement, and (c) an extent to which the contractor has completed at least one aspect of the construction project;
presenting the received draw request to a representative of the lender;
receiving input from the lender representative specifying an adjusted portion of the total loan amount to disburse;
determining whether the processing policies stored for the lender provide authorization for the lender representative to independently specify the adjusted portion; and
in response to determining that the processing policies stored for the lender provide authorization for the lender representative to specify the adjusted portion, causing the adjusted portion to be paid to the contractor in a loan disbursement irrespective of endorsement by a loan officer.

2. The method of claim 1, further comprising:
determining whether the processing policies stored for the lender specify that a loan officer be notified of the lender representative's specification of the adjusted portion; and
in response to determining that the processing policies stored for the lender provide authorization for the lender representative's specification of the adjusted portion, causing a loan officer to be notified of the adjusted portion.

3. The method of claim 1, further comprising:
before receiving the draw request from the contractor:
receiving input from the contractor proposing a budget for the construction project, the input specifying, for each of a plurality of budget line items, (a) a line item category, and (b) a line item amount;
presenting the proposed budget to the lender representative;
receiving input from the lender representative specifying an adjusted line item amount for each of one or more of the budget line items;
determining whether the processing policies stored for the lender provide authorization for the lender representative to independently specify the adjusted budget line item amounts;
in response to determining that the processing policies stored for the lender provide authorization for the lender representative to specify the adjusted budget line item amounts, storing an adjusted version of the proposed budget reflecting the adjusted budget line item amounts irrespective of endorsement by a loan officer.

4. The method of claim 3 wherein the received draw request specifies, for each of one or more selected ones of the line items of the budget, (a) a portion of the adjusted amount for the line item for which the contractor seeks disbursement, and (b) an extent to which the contractor has completed the line item,
and wherein the input received from the lender representative specifying an adjusted portion of the total loan amount to disburse comprises input specifying an adjusted amount for one or more of the selected line items.

5. The method of claim 4 wherein determining whether the processing policies stored for the lender provide authorization for the lender representative to independently specify the adjusted portion comprises, for each of the selected line items for which the lender representative specifies an adjusted amount, consulting a policy among the stored policy that is specific to the line item category of the selected line item.

6. The method of claim 5 wherein the consulted policy is specific to a soft cost line item category.

7. The method of claim 5 wherein the consulted policy is specific to a contractor profit and overhead line item category.

8. The method of claim 5 wherein the consulted policy is specific to a contingency line item category.

9. The method of claim 5 wherein the consulted policy is specific to an undefined cost line item category.

10. The method of claim 3 wherein the input received from the lender representative specifying an adjusted portion of the total loan amount to disburse comprises input specifying an adjusted amount relating to retainage,
and wherein determining whether the processing policies stored for the lender provide authorization for the lender representative to independently specify the adjusted portion comprises consulting a policy among the stored policy that is specific to retainage.

11. The method of claim 1, further comprising:
before receiving the draw request from the contractor:
receiving adjusted processing policies of the lender for the identified loan; and
storing the received adjusted of processing policies of the lender for the identified loan,
wherein the determining determines whether the stored processing policies adjusted for the identified loan provide authorization for the lender representative to independently specify the adjusted portion.

12. The method of claim 1, further comprising:
before presenting the received draw request to a representative of the lender, backspace:
presenting the received draw request to a borrower for the loan; and
receiving the borrower's endorsement of the received draw request it

13. The method of claim 1, further comprising:
causing information about the adjusted portion to be presented to the contractor or a borrower for the loan.

14. One or more memories collectively storing a construction loan management policy data structure, the data structure comprising an entry for each of a plurality of lenders, each entry comprising:
information identifying the lender; and
for each of a plurality of construction project budget categories:
information specifying a loan processing policy for the construction project budget category,
the contents of the data structure being usable to automatically supervise the actions of a loan processor acting with respect to a draw request for a loan of an identified lender.

15. The one or more memories of claim 14, each entry further comprising information specifying a loan processing policy for modifying a proposed construction project budget for a loan of the lender.

16. The one or more memories of claim 14, each entry further comprising message content to automatically send in response to the submission of a draw request for a loan of the lender.

17. The one or more memories of claim 14, each entry further comprising message content to automatically send in response to the approval of a draw request for a loan of the lender.

18. The one or more memories of claim 14, each entry further comprising information specifying a minimum period of time between draw payments for loans of the lender.

19. One or more instances of computer-readable media collectively having contents configured to cause a computing system to perform a method system for processing a construction loan draw request on behalf of a lender, the method comprising:
receiving a draw request from a contractor, the draw request identifying a construction loan made by the lender for which the contractor is performing a construction project, the draw request indicating, for each of one or more selected line items of a budget for the identified construction loan, (a) an extent of completion of the line item, and (b) an amount of money claimed by the contractor for the line item;
presenting the received draw request to a representative of the lender;
receiving input from the lender representative specifying, for each of the selected line items, an approved amount;
accessing loan processing policies stored on behalf of the lender, the policies specifying for loans of the lender authorization limits for lender representatives with respect to each of a plurality of line item types;
for each of the selected line items:
determining a type of the selected line item; and
determining whether the specified approved amount for the selected line item exceeds the authorization limit with respect to the determined line item type specified by the policies; and
in response to determining that, for each of the selected line items, the specified approved amount for the selected line item does not exceed the authorization limit with respect to the determined line item type specified by the policies, causing a sum aggregated from the specified approved amounts for the selected line items to be paid to the contractor in a loan disbursement irrespective of endorsement by a loan officer.

20. The one or more instances of computer-readable and media of claim 19, the method further comprising:
before receiving the draw request;
receiving input specifying the accessed loan processing policies; and
storing on behalf of the lender the loan processing policies specified by the received input.

21. The one or more instances of computer-readable media of claim 19, the method further comprising:
before presenting the received draw request to a representative of the lender:
submitting an inspection request for the identified construction project with respect to the selected line items that indicates for each the extent of completion indicated by the draw request; and
receiving an inspection report in response to the submitted inspection request,
and wherein the received inspection report is presented in connection with the received draw request.

22. The one or more instances of computer-readable media of claim 19 wherein the accessed loan processing policies specify notification limits with respect to each of the plurality of line item types,
the method further comprising:
for each of the selected line items:
determining whether the specified approved amount for the selected line item exceeds the notification limit with respect to the determined line item type specified by the policies; and
where it is determined that the specified approved amount for the selected line item exceeds the notification limit with respect to the determined line item type specified by the policies, causing a notification of the specified approved amount to be generated for a loan officer.

23. The one or more instances of computer-readable media of claim 19, further comprising:
causing information about the specified approved amounts for the selected line items to be presented to the contractor.
